(19) United States
(12) Patent Application Publication
(10) Pub. No.: US 2011/0279278 A1
(43) Pub. Date: Nov. 17, 2011

(54) Monitoring and early warning alarm system for high voltage insulator failure

(76) Inventors: Munir A. Al-Absi, Dhahran (SA); Salam A. Zummo, Dhahran (SA); Uthman A. Baroudi, Dhahran (SA)

(21) Appl. No.: 12/801,025

(22) Filed: May 17, 2010

(51) Int. Cl. G08B 17/00

(52) U.S. Cl. 340/584

(57) ABSTRACT

The monitoring and early warning alarm system for high voltage insulator failure provides an early predictor for high voltage insulator failure, allowing repairmen to either already be on site when a high voltage insulator fails in order to expedite repair time, or allowing repair and/or replacement of a faulty insulator before the failure actually occurs. The monitoring and early warning alarm system includes a housing adapted for mounting on a high-voltage power line in proximity to a high voltage insulator associated therewith. A temperature sensor, a contamination sensor, a humidity sensor, or combinations thereof are mounted on the housing and the measured ambient temperature, pollutant contamination and humidity are compared with pre-selected threshold values of temperature, humidity and pollutant contamination. A transceiver transmits an alarm signal when the measured ambient temperature, the measured humidity and/or the measured ambient pollutant contamination are greater than the respective pre-selected threshold values.

### BACKGROUND OF THE INVENTION

1. Field of the Invention

The present invention relates to safety devices for high-voltage equipment, and particularly to a monitoring and early warning alarm system for high voltage insulator failure that provides for transmission of an alarm signal when environmental conditions exceed pre-selected threshold values, indicating the likelihood of high voltage insulator failure.

2. Description of the Related Art

FIG. 2 illustrates a typical high voltage insulator I. Conventional high-voltage transmission lines L typically use modular cap and pin insulators, such as high voltage insulator I. The wires or lines L are suspended from a string of substantially identical disc-shaped insulators D that are attached to each other with metal clevis pin or ball-and-socket links. The advantage of this design is that insulator strings with different breakdown voltages, for use with different line voltages, can be constructed by using different numbers of the basic units (i.e., different numbers of disc-shaped insulators D). The breakdown voltage of an insulator is the minimum voltage that causes a portion of the insulator to become electrically conductive.

If one of the insulator units D in the string breaks, it can be replaced without discarding the entire string. Such insulating discs are typically constructed of a ceramic or glass disc with a metal cap and pin cemented on either side. In order to make defective units obvious, glass units are designed with “Class B” construction; i.e., an overvoltage causes a puncture arc through the glass. The glass is heat-treated so that it will shatter, making the damaged unit visible. However, since the mechanical strength of the unit is unchanged, the insulator string stays together. Standard disc insulator units are ten inches in diameter and approximately 5¾ inches long, and can support a load of approximately 80-120 kN, with a dry flashover voltage of about 72 kV, and are rated at an operating voltage of 10-12 kV. However, the flashover voltage of a string is less than the sum of its component discs, since the electric field is not distributed evenly across the string but, rather, is strongest at the disc nearest to the conductor, which will flashover first. Metal grading rings are sometimes added around the lowest disc in order to reduce the electric field across that disk and improve flashover voltage.

Detection of a failed insulator requires either visual inspection or disruption of the normal electrical power supply. In other words, failure must first occur before repairs can be made. It would be desirable to provide an early predictor for high voltage insulator failure, allowing repairmen to either already be on site when the insulator fails, in order to expedite repair time, or to allow repair and/or replacement of a faulty insulator before the failure actually occurs. Thus, a monitoring and early warning alarm system for high voltage insulator failure solving the aforementioned problems is desired.

### SUMMARY OF THE INVENTION

The monitoring and early warning alarm system for high voltage insulator failure provides an early predictor for high voltage insulator failure, allowing repairmen to either already be on site when a high voltage insulator fails in order to expedite repair time, or allowing repair and/or replacement of a faulty insulator before the failure actually occurs. The monitoring and early warning alarm system for high voltage insulator failure transmits an alarm signal when environmental conditions exceed pre-selected threshold values, indicating the likelihood of high voltage insulator failure. The early warning alarm system includes a housing adapted for mounting on a high-voltage power line in proximity to a high voltage insulator associated with the high-voltage power line. Preferably, the housing is configured to simulate a conventional high voltage insulator string.

At least one sensor is mounted on the housing. The at least one sensor may be a temperature sensor for measuring ambient temperature, a contamination sensor for measuring ambient pollutant contamination, a humidity sensor for measuring ambient humidity, or combinations thereof. The contamination sensor preferably includes at least one dust sensor. The measured ambient temperature, pollutant contamination and humidity are processed into respective data signals by a conditioning circuit, and then fed to a controller. The controller compares the measured ambient temperature, the measured humidity and the measured ambient pollutant contamination with pre-selected threshold values of temperature, humidity and pollutant contamination.

A transceiver mounted on the housing transmits an alarm signal when the measured ambient temperature, the measured humidity and/or the measured ambient pollutant contamination are greater than the pre-selected threshold values of temperature, humidity and pollutant contamination, respectively. The transceiver, controller, and sensors may be powered by one or more batteries contained within the housing, or, alternatively, by at least one solar cell or solar panel mounted on the exterior of the housing. It should be understood that in addition to providing an early warning alarm, the system is also a continuous monitoring system for potential high voltage insulator failure.

These and other features of the present invention will become readily apparent upon further review of the following specification.

### BRIEF DESCRIPTION OF THE DRAWINGS

FIG. 1 is diagrammatic view of a monitoring and early warning alarm system for high voltage insulator failure according to the present invention.

FIG. 2 illustrates a typical prior art high voltage insulator string mounted on a high voltage power line.

FIG. 3 is a block diagram of the monitoring and early warning alarm system for high voltage insulator failure according to the present invention.

Similar reference characters denote corresponding features consistently throughout the attached drawings.

### DETAILED DESCRIPTION OF THE PREFERRED EMBODIMENTS

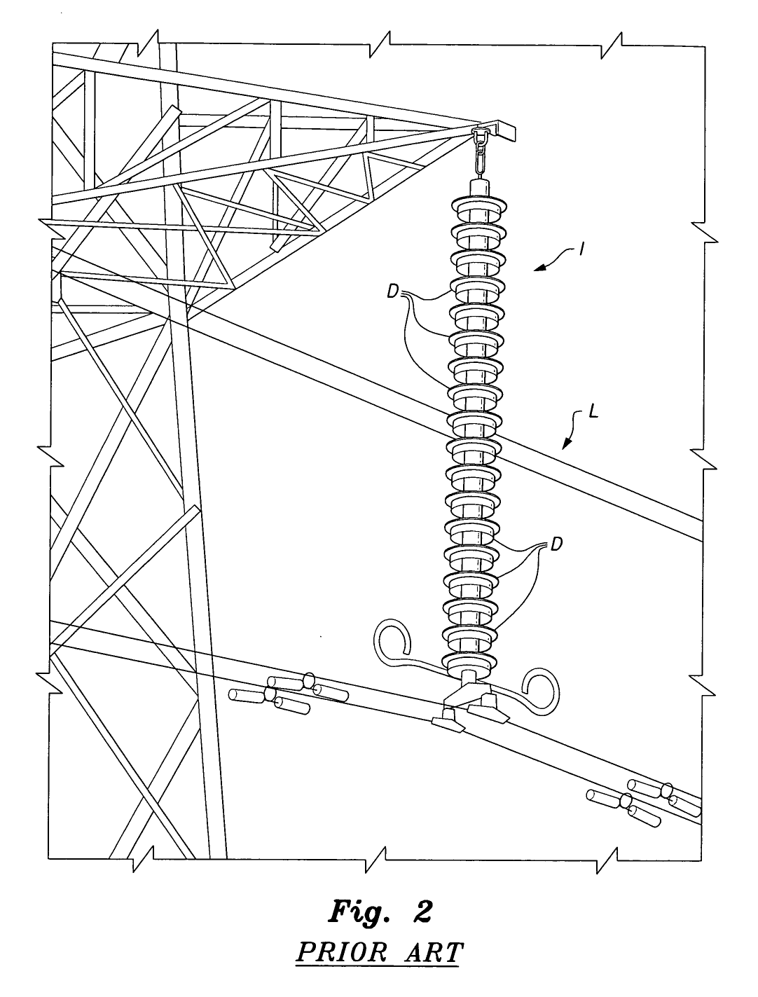

The monitoring and early warning alarm system for high voltage insulator failure 10 provides an early predictor for failure of a high voltage insulator, such as the typical high voltage insulator I of FIG. 2, allowing repairmen to either already be on site when the high voltage insulator I fails in order to expedite repair time, or allowing repair and/or replacement of the faulty insulator I before the failure actually occurs. The monitoring and early warning alarm system for high voltage insulator failure 10 transmits an alarm signal when environmental conditions exceed pre-selected threshold values, indicating the likelihood of high voltage insulator failure. Typically, insulator failure is due to environmental conditions, such as inclement weather and humidity, or accumulation of pollutants, including dust, pollen, industrial pollutants or the like. High temperature may also expedite failure of a high voltage insulator, and high temperatures being generated by insulators may also be indicative of impending failure. It should be understood that in addition to providing an early warning alarm, the system is also a continuous monitoring system for potential high voltage insulator failure.

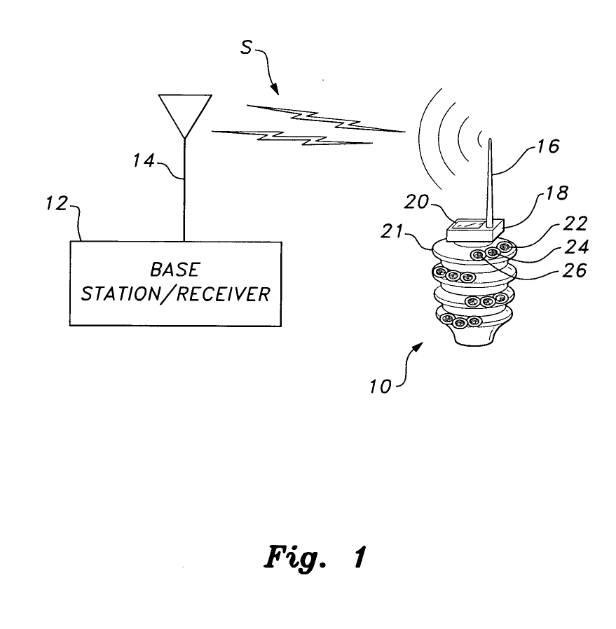

In addition to allowing repairmen to either already be on site when the high voltage insulator I fails in order to expedite repair time, or allowing repair and/or replacement of the faulty insulator I before the failure actually occurs, the early warning alarm system 10 is highly portable, allowing the system to be easily placed at differing areas of interest, as well as being easily transported, stored and replaced. As best shown in FIG. 1, the early warning alarm system 10 includes a housing 21 adapted for mounting on a high-voltage power line in proximity to a high voltage insulator associated with the high-voltage power line. For example, housing 21 may be mounted next to, or as part of, the insulator string I of FIG. 2. Preferably, the housing 21 is configured to simulate a conventional high voltage insulator string, as shown. Housing 21 forms a “dummy insulator”, simulating the appearance of a conventional high voltage insulator string and, as will be described in greater detail below, has at least one sensor mounted thereon (or at least partially housed therein), and further houses a sensor node, including a conditioning circuit, a controller and a transceiver.

At least one sensor is mounted on the housing 21. The at least one sensor may be a temperature sensor 22 for measuring ambient temperature, a contamination sensor 26 for measuring ambient pollutant contamination, a humidity sensor 24 for measuring ambient humidity, or combinations thereof. It should be understood that any suitable type of temperature sensor, humidity sensor or contamination/ambient pollution sensor may be utilized. The contamination sensor 26 preferably includes at least one dust sensor.

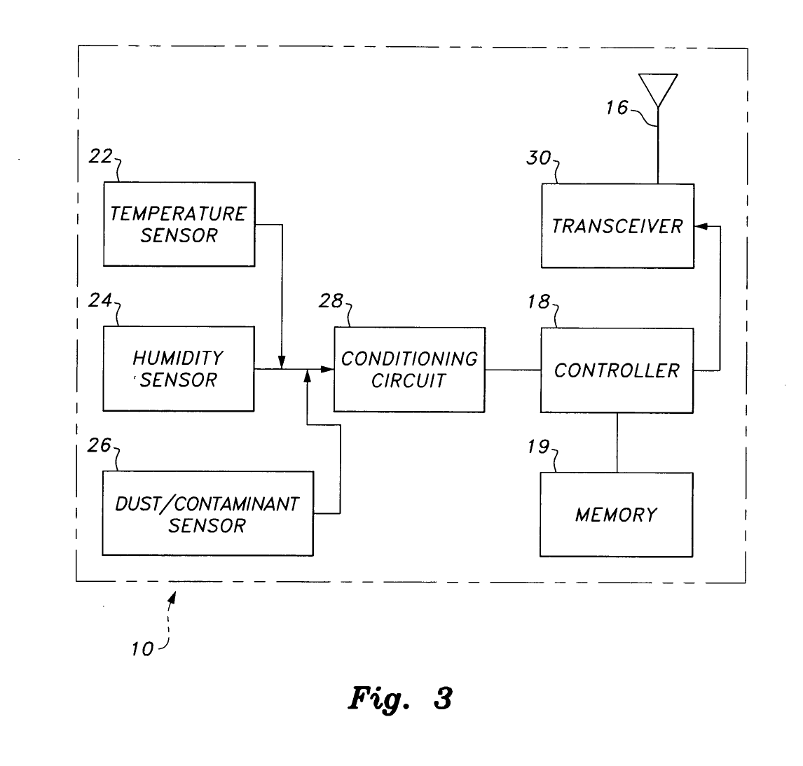

As illustrated in FIG. 3, the measured ambient temperature, pollutant contamination, and humidity are processed into respective data signals by a conditioning circuit 28 mounted within housing 21, and then fed to a controller 18. The controller 18 compares the measured ambient temperature, the measured humidity, and the measured ambient pollutant contamination with pre-selected threshold values of temperature, humidity and pollutant contamination. Computer readable memory 19 is provided for storing the pre-selected threshold values of temperature, pollutant contamination and humidity, and the computer readable memory 19 is in communication with controller 18, as shown. Preferably, controller 18 further includes, or is in communication with, an analog-to-digital converter. The “sensor node” associated with the dummy insulator includes temperature sensor 22, humidity sensor 24, and dust and/or contaminant sensor 26. The sensors in the sensor node monitor weather conditions the surrounding area, as well as contamination deposits on the dummy insulator. The outputs of the sensor node, as shown in FIG. 3, are delivered to conditioning circuit 28, with the signal being then output to controller 18 for data processing and manipulation.

A transceiver 30 mounted on the housing 21 transmits an alarm signal S when the measured ambient temperature, the measured humidity, and/or the measured ambient pollutant contamination are greater than the pre-selected threshold values of temperature, humidity and pollutant contamination, respectively. In FIG. 1, the alarm signal S is transmitted by the transceiver 30 and received by a base station and/or receiver 12, via an associated antenna 14. Upon receipt of the signal S, repair personnel can be dispatched to the site of potential insulator failure. Preferably, the location of the system 10 is also transmitted as part of signal S. By transmitting signal S when the threshold value or values are reached, repair of the insulator can be effectuated before actual failure; i.e., system 10 is used as a predictive and preventative tool to prevent insulator failure before it occurs. Alternatively, rather than transmitting signal S directly to the base station and/or receiver 12, which may be seen as a “main sensor node” or “main node”, the signal S may be delivered to an adjacent sensor node associated with another dummy insulator, and this sensor node will relay the sensed information to the next node using multi-hop relaying or any multi-hop wireless network protocol. The usage of the dummy insulator as a data collection source is a “plug-and-play” type device, which does not require shutting down the high voltage electric power utility network to install the device. The dummy insulator can be fixed on a support unit or it can be attached to the transmission tower (or in any other desired location). Several dummy insulators can be placed in the vicinity to assure a more accurate data collection. Additionally, it should be noted that the system can also be applied in an overhead transmission line power network. The dummy insulators in this configuration are placed at the tower just below the energized insulators. In this particular case, the area of interest is divided into a plurality of zones. Each zone is monitored using the dummy insulator and a wireless sensor network, a multi-hop wireless network or any other suitable wide area wireless network may be utilized to convey the collected data to an expert system in the command center 12.

The transceiver 30, controller 18, and sensors 22, 24, 26 may be powered by one or more batteries contained within the housing 21, or, alternatively, by at least one solar cell 20 or solar panel mounted on the exterior of the housing 21. Alternatively, system 10 may be interconnected with the power line associated with the string of high voltage insulators.

It should be understood that the conditioning circuit 28, the controller 18, and the memory 19 may be associated with, or incorporated into, any suitable type of computing device, for example, a personal computer or a programmable logic controller. The conditioning circuit 28, the controller 18, the memory 19 and any associated computer readable recording media are in communication with one another by any suitable type of data bus, as is well known in the art.

Examples of computer-readable recording media include a magnetic recording apparatus, an optical disk, a magneto-optical disk, and/or a semiconductor memory (for example, RAM, ROM, etc.). Examples of magnetic recording apparatus that may be used in addition to memory 112, or in place of memory 112, include a hard disk device (HDD), a flexible disk (ED), and a magnetic tape (MD. Examples of the optical disk include a DVD (Digital Versatile Disc), a DVD-RAM, a CD-ROM (Compact Disc-Read Only Memory), and a CD-R (Recordable)/RW.

It is to be understood that the present invention is not limited to the embodiments described above, but encompasses any and all embodiments within the scope of the following claims.

We claim:

1. A monitoring and early warning alarm system for high voltage insulator failure, comprising:
a housing adapted for mounting on a high-voltage power line in proximity to a high voltage insulator associated with the high-voltage power line;
a temperature sensor mounted on the housing for measuring ambient temperature;
a humidity sensor mounted on the housing for measuring ambient humidity;
means for comparing the measured ambient temperature and the measured ambient humidity with pre-selected threshold values of temperature and humidity; and
means for transmitting an alarm signal when the measured ambient temperature and the measured ambient humidity are greater than the pre-selected threshold values of temperature and humidity, respectively.

2. The monitoring and early warning alarm system for high voltage insulator failure as recited in claim 1, further comprising a contamination sensor mounted on the housing for measuring ambient pollutant contamination.

3. The monitoring and early warning alarm system for high voltage insulator failure as recited in claim 2, wherein the contamination sensor includes a dust sensor.

4. The monitoring and early warning alarm system for high voltage insulator failure as recited in claim 3, further comprising means for comparing the measured ambient pollutant contamination with a pre-selected threshold value of pollutant contamination.

5. The monitoring and early warning alarm system for high voltage insulator failure as recited in claim 1, further comprising at least one solar cell mounted on said housing for providing power to said early warning alarm system for high voltage insulator failure.

6. The monitoring and early warning alarm system for high voltage insulator failure as recited in claim 1, further comprising computer readable memory for storing the pre-selected threshold values of temperature and humidity, said means for comparing the measured ambient temperature and the measured ambient humidity with the pre-selected threshold values of temperature and humidity further comprising a controller in communication with the computer readable memory.

7. The monitoring and early warning alarm system for high voltage insulator failure as recited in claim 6, wherein said means for transmitting the alarm signal comprises a transceiver mounted on said housing, said transceiver being configured to transmit said alarm signal to an adjacent sensor node.

8. The monitoring and early warning alarm system for high voltage insulator failure as recited in claim 7, wherein said transceiver comprises means for transmitting said alarm signal to the adjacent sensor node by multi-hop relaying.

9. A monitoring and early warning alarm system for high voltage insulator failure, comprising:
a housing adapted for mounting on a high-voltage power line in proximity to a high voltage insulator associated with the high-voltage power line;
a temperature sensor mounted on the housing for measuring ambient temperature;
a contamination sensor mounted on the housing for measuring ambient pollutant contamination;
means for comparing the measured ambient temperature and the measured ambient pollutant contamination with pre-selected threshold values of temperature and pollutant contamination; and
means for transmitting an alarm signal when the measured ambient temperature and the measured ambient pollutant contamination are greater than the pre-selected threshold values of temperature and pollutant contamination, respectively.

10. The monitoring and early warning alarm system for high voltage insulator failure as recited in claim 9, wherein the contamination sensor includes a dust sensor.

11. The monitoring and early warning alarm system for high voltage insulator failure as recited in claim 10, further comprising a humidity sensor mounted on said housing for measuring ambient humidity.

12. The monitoring and early warning alarm system for high voltage insulator failure as recited in claim 11, further comprising means for comparing the measured ambient humidity with a pre-selected threshold value of humidity.

13. The monitoring and early warning alarm system for high voltage insulator failure as recited in claim 9, further comprising at least one solar cell mounted on said housing for providing power to the early warning alarm system for high voltage insulator failure.

14. The monitoring and early warning alarm system for high voltage insulator failure as recited in claim 9, further comprising computer readable memory for storing the pre-selected threshold values of temperature and pollutant contamination, said means for comparing the measured ambient temperature and the measured ambient pollutant contamination with the pre-selected threshold values of temperature and pollutant contamination comprising a controller in communication with the computer readable memory.

15. The monitoring and early warning alarm system for high voltage insulator failure as recited in claim 14, wherein said means for transmitting the alarm signal comprises a transceiver mounted on said housing.

16. The monitoring and early warning alarm system for high voltage insulator failure as recited in claim 9, wherein said housing is configured to simulate a high voltage insulator.

17. A monitoring and early warning alarm system for high voltage insulator failure, comprising:
a housing adapted for mounting on a high-voltage power line in proximity to a high voltage insulator associated with the high-voltage power line;
a humidity sensor mounted on the housing for measuring ambient humidity;
a contamination sensor mounted on the housing for measuring ambient pollutant contamination;
means for comparing the measured ambient humidity and the measured ambient pollutant contamination with pre-selected threshold values of humidity and pollutant contamination; and
means for transmitting an alarm signal when the measured ambient humidity and the measured ambient pollutant contamination are greater than the pre-selected threshold values of humidity and pollutant contamination, respectively.

18. The monitoring and early warning alarm system for high voltage insulator failure as recited in claim 17, wherein the contamination sensor includes a dust sensor.

19. The monitoring and early warning alarm system for high voltage insulator failure as recited in claim 18, further comprising a temperature sensor mounted on said housing for measuring ambient temperature.

20. The monitoring and early warning alarm system for high voltage insulator failure as recited in claim 19, further comprising means for comparing the measured ambient temperature with a pre-selected threshold value of temperature.
